(19) United States
(12) Patent Application Publication
(10) Pub. No.: US 2004/0139988 A1
(43) Pub. Date: Jul. 22, 2004

(54) Device and method for separating substances

(76) Inventors: Michael Haubs, Bad Kreuznach (DE); Reinhard Wagener, Hofheim (DE)

Correspondence Address: CONNOLLY BOVE LODGE & HUTZ, LLP, P O BOX 2207, WILMINGTON, DE, 19899, US

(21) Appl. No.: 10/450,691

(22) PCT Filed: Nov. 26, 2001
(86) PCT No.: PCT/EP01/13720

(30) Foreign Application Priority Data
Dec. 13, 2000 (DE) 100 61 887.1

(51) Int. Cl. B08B 7/04

(52) U.S. Cl. 134/10; 134/34; 134/111; 134/133; 134/186; 134/188

(57) ABSTRACT

The invention relates to a device for separating substances by means of countercurrent washing, having a container with a first end region, at which a first inlet orifice for the ingress of a substance mixture and a first outlet orifice for the egress of a substance component to be separated from the substance mixture and of a washing fluid are provided, with a second end region which is located axially opposite the first end region and at which a second inlet orifice for the ingress of the washing fluid and a second outlet orifice for the egress of a further substance component of the substance mixture and of the washing fluid are provided, and with a displacement region which is provided between the first end region and the second end region, the displacement region merging into the second end region by a transitional cross section. The device is characterized, according to the invention, in that a feed means, which is connected conductively to the second inlet orifice, is arranged in the region of the transitional cross section for introducing the washing fluid over a large area, and in that at least one movement member is provided for the controlled introduction of kinetic energy into the displacement region. The invention relates, furthermore, to a method for separating substances by washing with a washing fluid.

The invention relates to a device for separating substances by means of countercurrent washing, according to the preamble of claim 1, and to a method for separating substances by means of countercurrent washing, according to the preamble of claim 15.

A generic device has a container with a first end region, at which a first inlet orifice for the ingress of a substance mixture and a first outlet orifice for the egress of a substance component to be separated from the substance mixture and of a washing fluid are provided, a second end region which is located axially opposite the first end region and at which a second inlet orifice for the ingress of the washing fluid and a second outlet orifice for the egress of a further substance component of the substance mixture and of the washing fluid are provided, and also a displacement region which is provided between the first end region and the second end region, the displacement region merging into the second end region by means of a transitional cross section.

In a generic method, a substance mixture having at least one substance component to be separated and having a further substance component is introduced into a container at a first end region, and the washing fluid is introduced, in countercurrent to the substance mixture, into the container at a second end region which is located opposite the first end region with respect to a direction of gravity. The washing fluid displaces the at least one substance component to be separated at least partially out of the substance mixture in a displacement region of the counter, and the displaced substance component is discharged from the container at the first end region and the washing fluid, together with the at least one further substance component, is discharged from the container at the second end region.

Such devices and methods are used, for example, in order to replace one liquid constituent of a suspension by another liquid constituent.

DE 25 11 497 discloses a method in which an exchange column is supplied from above with a heavy quantity stream and from below with a washing fluid as a light quantity stream. Bottoms and passages are arranged in the exchange column, so that individual displacement chambers are formed. The heavy quantity stream flows into the individual chambers from above and is set in rotational movement by the bottoms and passages. The heavy quantity stream serves in this case as a propulsive jet which sucks in washing fluid, via special passages in the bottoms, from a chamber lying further below, in such a way that an intensive intermixing between the heavy quantity stream and the washing fluid takes place. What is to be achieved thereby is that at least one specific substance component of the heavy quantity stream is displaced out of the substance mixture, and that a further substance component is separated by sedimentation, in which case the further substance component is deposited in a lower region of the exchange column and is to be capable of being discharged from there.

In a device known from DE 25 11 497, complicated bottoms and passages have to be installed as guide elements in order to generate a desired flow behavior in the containers, which increases the overall cost of the device. Furthermore, the range of use of such devices having guide elements mounted fixedly inside the container is also restricted, since the flow behavior depends on the composition of the substance mixture and of the washing fluid and therefore a specific guide element geometry can be used only for specific substance mixtures and washing fluids.

A precondition for carrying out the known method is that a desired stable flow behavior is established within the exchange column. In practice, however, the establishment of a stable flow behavior of this kind is extremely difficult and scarcely achievable, since flow channels are very easily formed in the container and, furthermore, the individual initial substances often have pronounced fluctuations in their qualitative and quantitative composition. In addition, the intensive intermixing of the substance mixture and of the washing fluid which is sought after in the generic prior art counteracts an efficient displacement of a substance component out of the substance mixture.

A generic device and a generic method are described in EP 0 719 576 A1. In order to keep a substance mixture in the container distributed as uniformly as possible, it is proposed to provide an agitator means in a lower region of the container. Moreover, it teaches to subdivide a middle region of the container into a multiplicity of passage orifices arranged parallel to one another.

The object on which the invention is based is to provide a device and a method which can be used in a particularly versatile way and by means of which a simple and at the same time particularly efficient separation of two different substance components becomes possible. The device is also to have as simple and as cost-effective a construction as possible.

The invention achieves this object, in terms of the device, by means of the device according to patent claim 1 and, in terms of the method, by means of the method according to patent claim 15.

Preferred embodiments of the device and advantageous developments of the method are claimed in the subclaims.

A device of the type specified above is developed, according to the invention, in that a feed means, which is connected conductively to the second inlet orifice, is arranged in the region of the transitional cross section for introducing a washing fluid over a large area, and in that at least one movement member is provided for the controlled introduction of kinetic energy into the displacement region.

A fundamental ideal of the invention is that a flow behavior favorable for substance separation can be achieved within the container by the washing fluid being introduced over a large area.

This gave rise to the surprising finding that outstanding degrees of separation of well above 90% can be achieved within the container, without complicated fittings, such as, for example, guide elements.

With the aid of the movement member, the flow behavior of the substance mixture and the washing fluid in the displacement region can be influenced in a controlled manner in a structurally simple way and the formation of flow channels can be effectively suppressed.

The outlay in structural terms and therefore the production costs can consequently be markedly reduced, along with a method result which is just as good or is even improved.

In an advantageous development of the device according to the invention, the feed means has an outlet region which faces the transitional cross section, and the outlet area is designed for a uniform introduction of the washing fluid into the displacement region over the entire transitional cross section.

One reason for the very good method results when the washing fluid is introduced into the displacement region over a large area, that is to say with a flow density which is essentially uniform over the transitional cross section, may be seen in that very few turbulences are generated in the edge regions.

Preferably, in this case, the movement member is designed as a crossbar agitator. Such a crossbar agitator has a plurality of agitator elements arranged in a cross-like manner perpendicularly to the shaft.

Preferably, the container is of rotationally symmetric design. The container can then be manufactured in a simple way from a tube, in particular a metal tube.

The crossbar agitator can be arranged axially in the container and be capable of being driven in rotation via a drive means.

This makes it possible to have an arrangement in which the crossbars in each case pass essentially through an entire cross-sectional area of the displacement region.

Particularly good results can be achieved by means of a device in which a shaft of an agitator means, for example of a crossbar agitator, is designed to be comparatively thick, for example with half the inside diameter of the container. In such an arrangement, very low velocity differences are achieved along the horizontal agitator elements.

In a particularly compact construction, the drive means is arranged at the first end region of the container, in particular on the end face. The drive may, however, also be placed at another point.

The introduction of the washing fluid into the displacement region of the container over a large area can be implemented particularly effectively when the washing fluid is conducted, as free of turbulence as possible, as far as the outlet region of the feed means. This may be achieved, for example, in that the second inlet orifice is arranged at the second end region of the container on the end face.

In a further embodiment of the device according to the invention, a radially widened region, in which the feed means is received, is provided at the second end region of the container. The radially widened region is conducive to as turbulence-free a flow as possible and, furthermore, allows a good diversion of the solid particles around the feed means.

Furthermore, a further radially widened region may be provided at the first end region of the container. With the aid of such a further radially widened region, in particular below the first outlet orifice, the flow can be slowed in the first end region of the container, so that the sedimentation of solid constituents is improved and an egress of solid constituents from the first outlet orifice can be prevented.

Moreover, in a preferred embodiment, the outlet region of the feed means is designed with a multiplicity of small orifices for the uniform introduction of the washing fluid into the displacement region. An essentially uniform flow density of the washing fluid can be achieved thereby.

Particularly few turbulences occur in the displacement region when an area of the outlet region corresponds to an area of the transitional cross section of the displacement region. Then, with a suitable arrangement of the feed means, the jet profile of the washing fluid impinges exactly onto the transitional cross section and consequently into the displacement region.

The outlet region of the feed means may be formed, for example, from a porous material, in particular as a porous membrane, as a porous plate or as a frit consisting of glass or ceramic.

Such frits are well known in chemical engineering and process technology and are obtainable cost-effectively.

It is expedient, in this respect, that a mean pore size of the porous material is 0.1 μm to 1 mm, in particular 10 to 50 μm.

Preferably, the device according to the invention is arranged in such a way that the first end region of the container is arranged at the top and the second end region of the container at the bottom in relation to a direction of gravity. By means of such an arrangement, for example, heavy solid particles suspended in a first liquid can be separated from this liquid by means of the lighter washing fluid and extracted at the second outlet orifice. For example, such solid particles may be polymer flakes which are separated from a solvent.

However, a reversed arrangement of the device is also possible, that is to say an arrangement in which the first end region of the container is arranged at the bottom and the second end region of the container at the top in relation to a direction of gravity. This construction is expedient when solid particles are to be separated from a liquid which is heavier than the solid. One example of this is a method for obtaining drinking water from sea water, in which lighter ice particles are separated from heavier salt water, drinking water being used as washing fluid.

The method of the type specified above is developed, according to the invention, in that the washing fluid is introduced over a large area at a transitional cross section by which the displacement region merges into the second end region, and in that kinetic energy is introduced into the displacement region of the container in a controlled manner by means of at least one movement member.

The method according to the invention is again based on the finding, as essential idea, that outstanding method results can be achieved by means of an introduction of the washing fluid over a large area, and that, in principle, guide elements or chamberings within the container are no longer necessary.

The formation of flow channels can be effectively suppressed with the aid of the movement member.

Preferably, the washing fluid is introduced into the displacement region uniformly over the entire transitional cross section. Vortex formation can thereby be reduced.

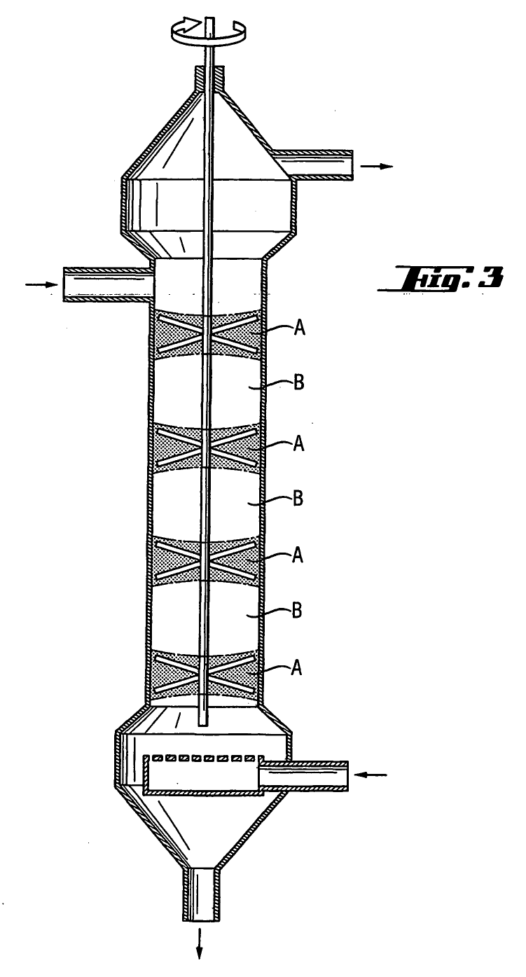

It is advantageous, in particular, when the movement or agitator member has, instead of blades or comparable sheet-like elements by means of which turbulences are introduced to a great extent into the liquid in the container, narrow tubes or bars directed essentially perpendicular to the shaft. Agitation is then carried out essentially in the form of a horizontal or two-dimensional agitation or mixing, turbulences being avoided as far as possible. As a result of such a procedure, agitated zones arise next to nonagitated regions (cf. FIG. 3). Displacement washing takes place in the nonagitated regions, while a formation of flow channels is suppressed by the agitated zones.

It became clear that particularly good results are achieved with comparatively low rotational speeds of an agitator means. For example, it is expedient that the movement member used is a crossbar agitator which is driven at a rotational speed of 0.1 rev/min to 100 rev/min, in particular at 0.5 rev/min to 10 rev/min.

As regards the use of material and energy, it is beneficial if the method is operated continuously in a steady state. In principle, however, noncontinuous or intermittent operation is also possible.

As regards the build-up of such a steady state, there is, in principle, a high degree of freedom in process control. Preferably, however, in a first method step, the substance mixture is introduced into the container through the first inlet orifice and, subsequently, a volume flow of the washing fluid is set in a controlled manner. Solid particles which may not yet be separated sufficiently from a liquid to be separated can then be fed to the device once again through the first inlet orifice.

The device according to the invention can be used in order to carry out the method according to the invention.

Further advantages and features of the device according to the invention and of the method according to the invention are explained below with reference to the diagrammatic drawings, in which:

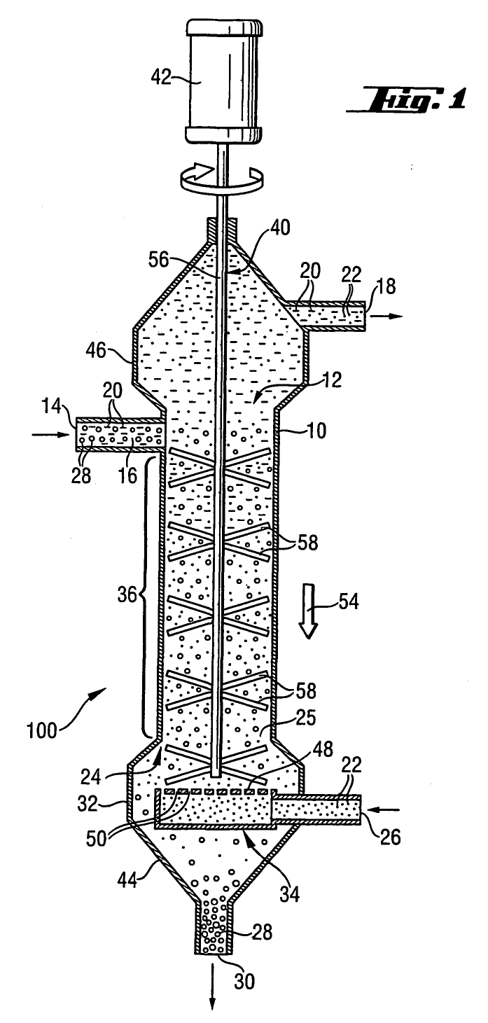

FIG. 1 shows a diagrammatic illustration of a first embodiment of the device according to the invention, and

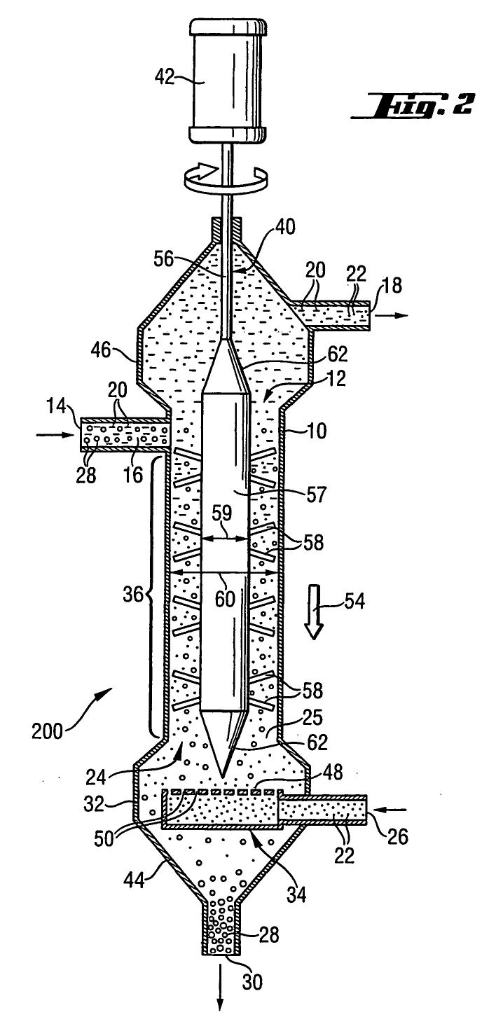

FIG. 2 shows a diagrammatic illustration of a further embodiment of the device according to the invention.

FIG. 3 shows a diagrammatic illustration of the controlled introduction of kinetic energy into the displacement region.

FIG. 1 shows a device 100 according to the invention, essential component of which is a container 10. A first inlet orifice 14 is provided at a first end region 12 of the container 10. A second inlet orifice 26 is provided at a second end region 24 and a second outlet orifice 30 is provided after a radially widened region 32 and a conically tapering region 44. A first outlet orifice 18 is located at the first end region 12, after a further radially widened region 46.

The container 10 has essentially a rotationally symmetric shape. Between the first end region 12 and the second end region 24 is located a displacement region 36, in which a shaft 56 of a crossbar agitator 40 is arranged axially. A plurality of crossbars 58 are fastened to the shaft 56. For the rotating drive of the shaft 56, a drive means 42 is arranged on one end face at the first end region 12 of the container 10. The displacement region 36 merges into the second end region 24 by a transitional cross section 25.

The second inlet orifice 26 is connected conductively to a feed means 34 which has an outlet region 48. In this case, according to the invention, the outlet region 48 faces the transitional cross section 25 and is designed for introducing the washing fluid 22 over a large area into the displacement region 36.

The outlet region 48 is provided with a multiplicity of small orifices 50 and is preferably produced as a glass frit with a mean pore size between 10 and 50 μm.

The device 100 shown in FIG. 1 is oriented in such a way that the first end region 12 is at the top and the second end region 24 at the bottom in relation to a direction of gravity 54.

Such an orientation makes it possible to separate a substance mixture 16 consisting of a lighter liquid substance component 20 and of heavier solid particles 28, for example polymer flakes.

The execution of the method according to the invention by means of the device. 100 illustrated in FIG. 1 is described below.

First, the substance mixture 16 is introduced into the first inlet orifice 14. Moreover, the washing fluid 22 is introduced into the second inlet orifice 26. This may, in principle, take place both before and after the supply of the substance mixture 16, but is preferably carried out after the introduction of the substance mixture 16. The container 10 is then first filled with the mixture of the liquid substance component 20 to be separated and the solid particles 28 which by virtue of gravity sink downward, that is to say are sedimented.

Subsequently, the washing fluid 22 is introduced into the second inlet orifice 26 and flows upward in countercurrent to the substance mixture 16 in the container 10. The supply of the washing fluid and/or of the substance mixture 16 in terms of volume is then set in a controlled manner until good substance separation results are achieved in a steady state.

As a result of the washing fluid 32 being introduced into the displacement region 36 of the container 10 over a large area according to the invention, an intimate interaction occurs in the displacement region between the substance mixture 16 and the washing fluid 22 and results in a virtually complete separation of the substance component 20 from the solid particles 28.

A mixture of the liquid substance component 20 and of the washing fluid 22 then emerges at the first outlet orifice 18. The desired solid particles 28 freed from the liquid substance component 20 can be extracted from the container 10 at the second outlet orifice 30.

FIG. 2 illustrates a further exemplary embodiment of a device 200 according to the invention. The construction of the device 200 from FIG. 2 corresponds essentially to that of the device 100 from FIG. 1. Corresponding parts are therefore marked by the same reference symbols and only the differences are described below.

In contrast to the device 100 from FIG. 1, the device 200 from FIG. 2 has a crossbar agitator 40 with a thickened region 57 of a shaft 56. This thickened region 57 extends essentially over the entire displacement region 36 of the container 10. The agitator elements 58, shown diagrammatically, run horizontally, that is to say perpendicularly to the shaft 56.

A diameter 59 of the shaft 56 in the thickened region 57 is about half an inside diameter 60 of the container 10. In the first end region 12 and in the second end region 24 of the container 10, the thickened region 57 of the shaft 56 has conically tapering end regions 62 which counteract a turbulence of the liquids and are conductive to a laminar flow.

In this device, countercurrent washing takes place in a tubular region of the displacement region 36. This affords the advantage that, in contrast to the device 100 from FIG. 1, the liquid particles have markedly lower velocity differences. Vortex formation in the container 10 can thereby be reduced.

Overall, in the device 200, countercurrent washing in the container 10 takes place in an essentially laminar flow which is agitated or intermixed horizontally or two-dimensionally as a result of a slow rotation of the crossbar agitator 40. By means of such a device 200, outstanding washing and separating results markedly better than 90% can be achieved.

1. A device for separating substances by means of countercurrent washing, having a container (10) with
a first end region (12), at which a first inlet orifice (14) for the ingress of a substance mixture (16) and a first outlet orifice (18) for the egress of a substance component (20) to be separated from the substance mixture (16) and of a washing fluid (22) are provided,
a second end region (24) which is located axially opposite the first end region (12) and at which a second inlet orifice (26) for the ingress of the washing fluid (22) and a second outlet orifice (30) for the egress of a further substance component (28) of the substance mixture (16) and of the washing fluid (22) are provided, and
a displacement region (36) which is provided between the first end region (12) and the second end region (24), the displacement region (36) merging into the second end region (24) by a transitional cross section (25),
characterized
in that a feed means (34), which is connected conductively to the second inlet orifice (26), is arranged in the region of the transitional cross section (25) for introducing the washing fluid (22) over a large area, and
in that at least one movement member is provided for the controlled introduction of kinetic energy into the displacement region (36).

2. The device as claimed in claim 1, characterized in that the feed means (34) has an outlet region (48) which faces the transitional cross section (25), and in that the outlet region (48) is designed for a uniform introduction of the washing fluid (22) into the displacement region (36) over the entire transitional cross section (25).

3. The device as claimed in one of claims 1 or 2, characterized in that the movement member is designed as a crossbar agitator (40).

4. The device as claimed in one of claims 1 to 3, characterized in that the container (10) is of rotationally symmetric design.

5. The device as claimed in claim 4, characterized in that the crossbar agitator (40) is arranged axially in the container (10) and can be driven in rotation via a drive means (42).

6. The device as claimed in claim 5, characterized in that the drive means (42) is arranged at the first end region (12) of the container (10), in particular on the end face.

7. The device as claimed in one of claims 1 to 6, characterized in that the second inlet orifice (26) is arranged at the second end region (24) of the container (10) on the end face.

8. The device as claimed in one of claims 1 to 7, characterized in that a radially widened region (33), in which the feed means (34) is received, is provided at the second end region (24) of the container (10).

9. The device as claimed in one of claims 1 to 8, characterized in that a further radially widened region (46) is provided at the first end region (12) of the container (10).

10. The device as claimed in one of claims 1 to 9, characterized in that the outlet region (48) of the feed means (34) is designed with a multiplicity of small orifices (50) for the uniform introduction of the washing fluid (22) into the displacement region (36).

11. The device as claimed in one of claims 1 to 10, characterized in that an area of the outlet region (48) corresponds to an area of the transitional cross section (25) of the displacement region (36).

12. The device as claimed in one of claims 1 to 11, characterized in that the outlet region (48) of the feed means (34) is formed from a porous material, in particular as a porous diaphragm, as a porous plate or as a frit consisting of glass or ceramic.

13. The device as claimed in claim 12, characterized in that a mean pore size of the porous material is 0.1 μm to 1 mm, in particular 10 to 50 μm.

14. The device as claimed in one of claims 1 to 13, characterized in that the first end region (12) of the container (10) is arranged at the top and the second end region (24) of the container (10) at the bottom in relation to a direction (54) of gravity.

15. A method for separating substances by means of countercurrent washing, in which
a substance mixture (16) with at least one substance component (20) to be separated and with at least one further substance component (28) is introduced into a container (10) at a first end region (12),
the washing fluid (22) is introduced into the container (10), in countercurrent to the substance mixture (16), at a second end region (24) which is located opposite the first end region (12) in relation to a direction (54) of gravity,
the washing fluid (22) displaces the at least one substance component (20) to be separated at least partially out of the substance mixture (16) in a displacement region (36) of the container (10), and
the displaced substance component (20) is discharged from the container (10) at the first end region (12) and the washing fluid (22), together with the at least one further substance component (28), is discharged from the container (10) at the second end region (24),
characterized
in that the washing fluid (22) is introduced over a large area at a transitional cross section (25) by which the displacement region (36) merges into the second end region (24), and
in that kinetic energy is introduced into the displacement region (36) of the container (10) in a controlled manner by means of least one movement member.

16. The method as claimed in claim 15, characterized in that the washing fluid (22) is introduced into the displacement region (36) uniformly over the entire transitional cross section (25).

17. The method as claimed in one of claims 15 or 16, characterized in that the movement member used is a crossbar agitator (40) which is driven at a rotational speed of 0.1 rev/min to 100 rev/min, in particular at 0.5 rev/min to 10 rev/min.

18. The method as claimed in one of claims 15 to 17, characterized in that, in a first method step, the substance mixture (16) is introduced into the container (10) through the first inlet orifice (14), and in that, subsequently, a volume flow of the washing fluid (22) is set in a controlled manner.

19. The method as claimed in one of claims 15 to 18, characterized in that the method is operated continuously in a steady state.
